(19) United States
(12) Patent Application Publication
(10) Pub. No.: US 2012/0322300 A1
(43) Pub. Date: Dec. 20, 2012

(54) ELECTRICAL QUICK CONNECTION APPARATUS

(76) Inventor: Peter J. Arrias, San Clemente, CA (US)

(21) Appl. No.: 13/162,229

(22) Filed: Jun. 16, 2011

(51) Int. Cl. H01R 13/66

(52) U.S. Cl. 439/536

(57) ABSTRACT

A method and a device are disclosed to allow quick connection, substantially without tools, of electrical wire segments and modular components. In one embodiment, a quick connect electrical junction box is disclosed configured to allow the quick connection of two or more cable segments using a connection terminal block having electrical terminals, which are configured to conductively couple one or more bare wires together. In another embodiment, a quick connect electrical junction box is disclosed configured to allow the quick connection of two or more cable segments, and further configured to electrically couple modular electrical components, such as receptacles and switches, with the two cable segments.

### TECHNICAL FIELD

This application relates generally to electrical wiring. More specifically, this application relates to apparatus for quick inter connection of wires and electrical components.

### BRIEF DESCRIPTION OF THE DRAWINGS

The drawings, when considered in connection with the following description, are presented for the purpose of facilitating an understanding of the subject matter sought to be protected.

FIG. 1 shows an example connection between two electrical wire segments;

FIG. 2 shows an example quick connect electrical junction box configured to allow quick connection of two electrical wire segments;

FIG. 3 shows an example quick connect electrical junction box configured to allow connection with modular electrical components; and

FIG. 4 shows an example quick connect terminal block configured to allow connection of additional electrical lines with an existing line.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references receptacles and switches as electrical components, it will be appreciated that the disclosure may be used for other modular electrical components, such as dimmers, light fixtures, and the like.

Briefly described, an apparatus and a method are disclosed operable to allow quick connection, substantially without tools, of electrical wire segments and modular components. In one embodiment, a quick connect electrical junction box is disclosed configured to allow the quick connection of two or more cable segments using a connection terminal block having electrical terminals, which are configured to conductively couple one or more bare wires together. In another embodiment, a quick connect electrical junction box is disclosed configured to allow the quick connection of two or more cable segments, and further configured to electrically couple modular electrical components, such as receptacles and switches, with the two cable segments.

Electrical wiring of buildings and facilities is an integral part of construction work in modern life. Due to its importance in modern life in powering various electrical devices, and the dangers of faulty wiring, such as electrical fires, electrocution, and the like, electrical wiring of buildings is generally done according to municipal building codes by certified electricians. As such, electrical wiring is expensive and time consuming. Methods for reliable and quick connection of electrical wires and components may reduce cost and time of electrical wiring.

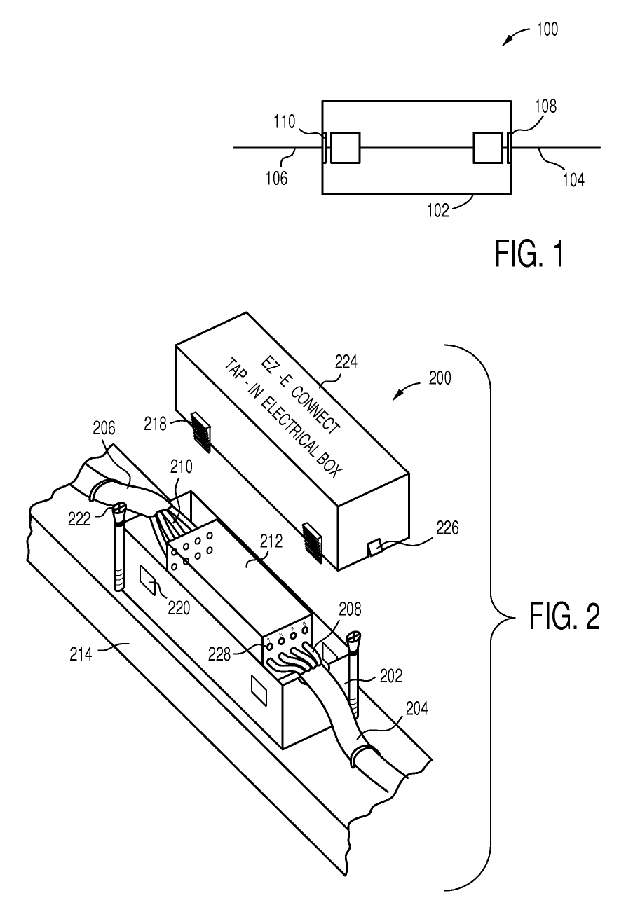

FIG. 1 shows an example connection between two electrical wire segments. In various embodiments, quick connection arrangement 100 includes electrical junction box 102 having terminals 108 and 110 configured to couple wire segments 104 and 106.

In some embodiments, multiple wire segments may be coupled together to extend an electrical cable. In various embodiments, terminals 108 and 110 include multiple ports to couple individual bare wires from a multi-wire cable to corresponding wires of another multi-wire electrical cable. This technique allows the extension of a short cable, the connection of a new cable to an existing cable, or the replacement of a damaged cable segment in an existing cable.

FIG. 2 shows an example quick connect electrical junction box configured to allow quick connection of two electrical wire segments. In various embodiments, quick connection arrangement 200 includes electrical junction box 202 enclosing terminal block 212, having multiple terminal ports 228 configured to couple individual wires 208 of electrical cable 204 with individual wires 210 of electrical cable 206. Electrical junction box 202 may further include screws 222 for attaching the junction box to building structural members 214, such as studs, joists, surfaces, and the like, and receiving holes 220 to receive locking tabs 218 of junction box cap 224. Junction box cap 224 may further include cable holding tabs 226 to press and hold electrical cable 204.

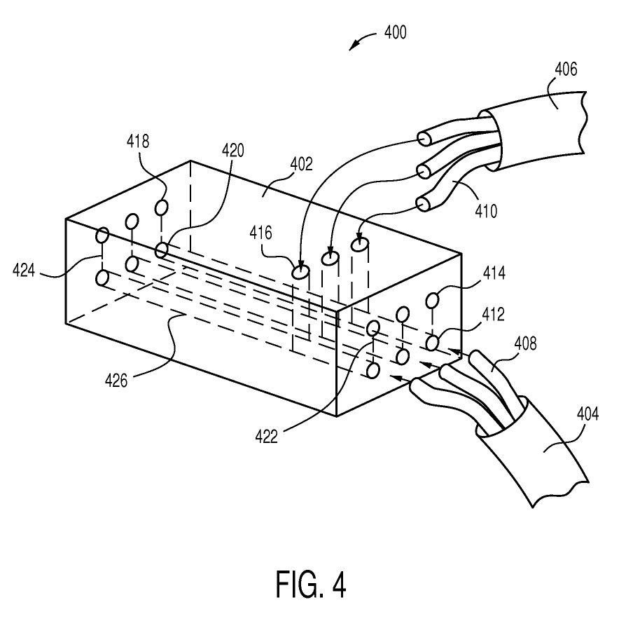

In various embodiments, one or more individual wires 208 are received into terminal ports 228 of terminal block 212 to be coupled to individual wires 210 of cable 206. As further detailed in FIG. 4, in some embodiments, terminal block 212 may include internal channels and structures for connecting different terminal ports 228 to each other for electrical conduction.

In operation, electrical junction box 202 may be attached to structural member 214 via fasteners, such as screws 222. Cap 224 may be removed to allow access to terminal block 212. Wires 208 from electrical cable 204 and wires 2310 from electrical cable 206 may be stripped from insulation to be inserted into terminal ports 228. This way, each wire from cable 204 may be electrically connected to the corresponding wire from cable 206 to create a single electrical cable or connection in a quick and reliable manner. Junction box cap 224 may then be snapped onto electrical junction box 202 by manual pressure, closing and electrically isolating electrical junction box 202. In various embodiments, electrical cables 204 and 206 are coupled together using electrical junction box 202 substantially without the use of tools, except the use of a wire stripper to strip wires 208 and 210.

In various embodiments, terminal ports 228 include a mechanism for retaining wires 208. For example, terminal ports 228 may include a spring loaded metal tube into which bare wire is inserted by force. In another embodiment, terminal ports 228 may retain a bare wire by pressure fitting the bare wire into the terminal ports, which have a slightly smaller diameter than the bare wire. In other embodiments, terminal ports 228 may retain inserted wires between split metal plates pressed together by a screw or other fastening mechanism. In still other embodiments, wires may be retained by a spring loaded grasping mechanism, such as a clip.

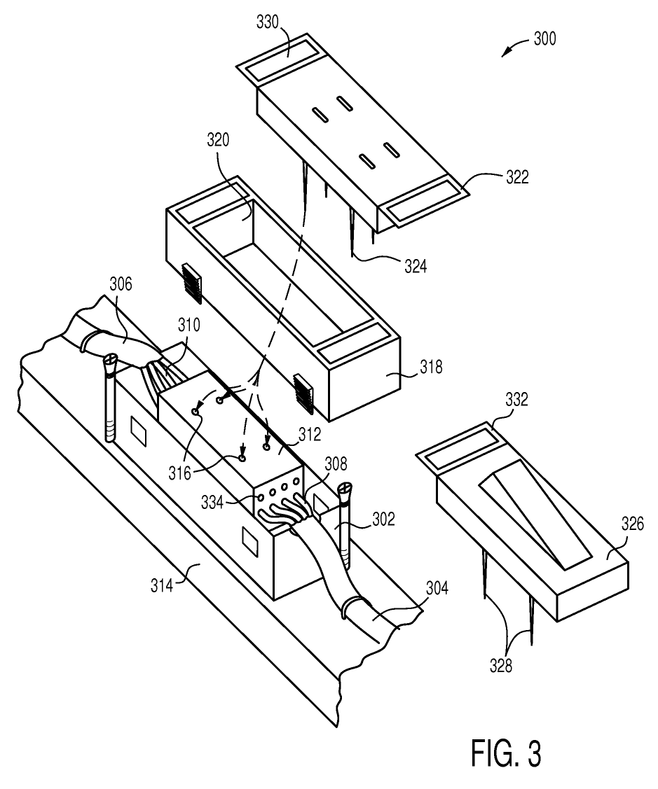

FIG. 3 shows an example quick connect electrical junction box configured to allow connection with modular electrical components. In various embodiments, quick connection arrangement 300 includes electrical junction box 302 with terminal block 312 having terminal ports 334 configured to receive 308 of cable 304 and wires 310 of cable 306. Electrical junction box 302 further includes component ports 316 configured to receive and couple modular electrical components 322 and 326 having electrical plugs 324 and 328, respectively, via shroud 318 and terminal block 312 to the electrical cables. Shroud 318 includes internal space 320 configured to contain and hold modular electrical components 322 and 326 using tabs 330 and 332, respectively. Modular electrical components 322 and 326 may include electrical receptacles, electrical switches, dimmers, lights, sensors like carbon monoxide sensors and smoke detectors, and the like.

In various embodiments, electrical junction box may be used both to couple electrical cables 304 and 306 to each other and to connect modular electrical components 322 and 332 to the electrical cables. The modular electrical components may be inserted into the junction box through component ports 316 and be electrically connected to the electrical cables, substantially without the use of tools. Each electrical component may function according to its design once inserted into the junction box. For example, a modular electrical switch may function to allow or inhibit flow of electrical current in the electrical cables, while a modular electrical receptacle may provide external access to the electricity flowing in the electrical cables.

FIG. 4 shows an example quick connect terminal block configured to allow connection of additional electrical lines with an existing line. In various embodiments, quick connect arrangement 400 includes terminal block 402 having terminal ports 412, 414, 416, 418, and 420 coupled together via internal lines 422, 424, and 426 as depicted in this FIGURE. Wires 408 and 410 of electrical cables 404 and 406, respectively, may be coupled to each other using the terminal ports located at different positions within terminal block 402. Thus, different cable segments may all be coupled together as one electrical node by being attached to different terminal ports internally connected within the terminal block.

In various embodiments, terminal block 402 may be used to connect to an existing electrical cable to extend electrical power substantially without the use of tools. In operation, an electrical cable may be split to create two cable segments, such as cable segment 404, strip wires 408, and insert the stripped wires into appropriate terminal ports, such as terminal ports 412 and 420. A different cable segment, such as cable 406 may then be connected to terminal block 402 via terminal ports 416, thus, extending the electrical power from cable 404 to cable 406. Other cable segments may further be connected to other terminal ports to further extend the electrical power network.

In various embodiments, terminal block 402 may include different electrical pathways, such as internal lines 422, 424, and 426, between different terminal ports to allow different connection configurations. For example, a first set of terminal ports may be connected to a second set, but not to a third set, allowing routing electrical power from one set of terminal ports to another set.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A quick connect electrical junction box comprising:
a terminal block enclosed within the electrical junction box having a plurality of sets of terminal ports configured to receive stripped electrical wires, wherein some of the plurality of sets of terminal ports are electrically connected to some other of the plurality of sets of terminal ports; and
a junction box cap configured to couple with and cover the electrical junction box.

2. The quick connect electrical junction box of claim 1, further comprising quick connect tabs on the junction box cap configured to quickly cover the electrical junction box substantially without use of tools.

3. The quick connect electrical junction box of claim 1, further comprising internal lines connecting some of the plurality of sets of terminal ports to each other.

4. The quick connect electrical junction box of claim 1, further comprising component ports configured to receive and connect modular electrical components to an electrical cable coupled with a power source.

5. The quick connect electrical junction box of claim 4, wherein the modular electrical components include one of an electrical receptacle, an electrical switch, and a dimmer.

6. The quick connect electrical junction box of claim 1, wherein the electrical junction box is configured to be attached to a structural member.

7. The quick connect electrical junction box of claim 1, wherein the terminal ports are configured to receive and hold stripped electrical wires substantially without use of tools.

8. The quick connect electrical junction box of claim 1, wherein the terminal ports are configured to hold stripped electrical wires by pressure fit.

9. A quick connect electrical junction box comprising:
a terminal block enclosed within the electrical junction box having a plurality of sets of terminal ports configured to receive stripped electrical wires, and further configured to receive modular electrical components to be connected to some of the plurality of sets of terminal ports; and
a junction box cap configured to couple with and cover the electrical junction box.

10. The quick connect electrical junction box of claim 9, further comprising a plurality of component ports configured to receive the modular electrical components.

11. The quick connect electrical junction box of claim 9, wherein the modular electrical components include one of an electrical receptacle, an electrical switch, and a dimmer.

12. The quick connect electrical junction box of claim 10, wherein the modular electrical components include electrical plugs configured to be received into the component ports.

13. The quick connect electrical junction box of claim 10, wherein some of the plurality of sets of terminal ports are electrically connected to the component ports.

14. The quick connect electrical junction box of claim 9, wherein the electrical junction box is configured to be attached to a structural member.

15. A method of quickly connecting electrical cables substantially without the use of tools, the method comprising:
attaching a quick connect electrical junction box to a structural member;
inserting, substantially without use of tools, a first stripped wire of a first electrical cable into a first terminal port of a terminal block enclosed in the quick connect electrical junction box; and
inserting, substantially without use of tools, a second stripped wire of a second electrical cable into a second terminal port of the terminal block, wherein the first terminal port and the second terminal port are electrically coupled.

16. The method of claim 15, further comprising a inserting, substantially without use of tools, a third stripped wire of a third electrical cable into a third terminal port of the terminal block, wherein the third terminal port is electrically coupled with the first terminal port and the second terminal port.

17. The method of claim 15, further comprising coupling a modular electrical component with the terminal block.

18. The method of claim 15, wherein the terminal block includes a component port.

19. The method of claim 18, wherein the first and second terminal blocks are electrically coupled with the component port.

20. The method of claim 15, wherein the first and the second terminal ports are configured to retain the first and second stripped wires, respectively.
